(19) United States
(12) Patent Application Publication
(10) Pub. No.: US 2026/0088687 A1
(43) Pub. Date: Mar. 26, 2026

(54) HAIRPIN FORMING APPARATUS FOR MOTOR OF ELECTRIC VEHICLE

(71) Applicants: Hyundai Motor Company, Seoul (KR); Kia Corporation, Seoul (KR); Pyeong Hwa Technology Co., Ltd., Changwon (KR); Hyundai Mobis Co., Ltd., Seoul (KR)

(72) Inventors: Seungwon Song, Hwaseong (KR); Chanui Park, Hwaseong (KR); Kyoung Min Park, Hwaseong (KR); Won Il Kim, Hwaseong (KR); Kyung Seok Yoo, Changwon (KR); Taek Soo Yang, Changwon (KR); Yong Seok Lim, Changwon (KR); Min Soo Kang, Seoul (KR)

(21) Appl. No.: 19/020,510

(22) Filed: Jan. 14, 2025

(30) Foreign Application Priority Data
Sep. 26, 2024 (KR) 10-2024-0130621

(51) Int. Cl. H02K 15/0421

(52) U.S. Cl. CPC H02K 15/0421

(57) ABSTRACT

A hairpin forming apparatus for a motor includes a stopper for sensing contact of a leading end of the material coil and aligning the leading end of the material coil at a predetermined position, a cutter for cutting the material coil aligned by the stopper to a predetermined length, a coil holder provided between the stopper and the cutter so that the material coil is placed thereon, and a press module for pressing and bending the material coil placed on the coil holder. The press module includes a die block fixed to the coil holder, a main press for pressing the material coil toward the die block to form a pin head and pin shoulders, and a side press for pressing both sides of the material coil located at positions deviating from the die block and the main press to form a pair of pin arms.

### CROSS-REFERENCE TO RELATED APPLICATION

The present application claims under 35 U.S.C. § 119(a) the benefit of Korean Patent Application No. 10-2024-0130621 filed on Sep. 26, 2024, the entire contents of which are incorporated herein by reference.

### BACKGROUND

### (a) Technical Field

The present disclosure relates to a hairpin forming apparatus for a motor of an electric vehicle, more particularly, to the hairpin forming apparatus configured to cut a material coil to a predetermined length and bend the cut material coil through a pressing process to form a pin head, pin shoulders, and pin arms.

### (b) Description of the Related Art

Electric vehicles are driven by motors. A motor produces kinetic energy using electric energy. Most motors include a stator and a rotor. The stator is wound with a highly conductive copper wire. When current flows through the wire, a magnetic field is formed around the stator. The rotor is implemented as a steel core or a magnet, and rotates under the influence of the magnetic field generated by the stator. The motor converts the electric energy supplied to the stator into the rotational motion of the rotor.

As the density per unit volume of the copper wire wound on the stator increases, the efficiency and performance of the motor may be improved. For this reason, a copper wire having a rectangular cross-section may be used in order to more densely wind the copper wire on the stator.

In addition, in order to improve the performance and efficiency of the motor, a method of transforming a copper wire, cut to a preset length, into a hairpin shape and then mounting the hairpin in a stator slot is widely used.

The hairpin is manufactured by processing a copper coil having a rectangular cross-section, and the surface thereof is coated with a thin insulating film. This insulating film is primarily composed of an insulative material such as enamel.

A plurality of hairpins is mounted in stator slots to form the stator, and the insulating film is required to prevent electrical short circuit between adjacent hairpins. Portions of the insulating film coated on two ends of each hairpin may be removed to expose the copper wire in order to achieve electrical connection to a circuit.

In the conventional manufacturing method, processes such as bending, stripping, and cutting are sequentially performed on a copper wire that is fed in real time. However, because times required for the respective processes are different from each other, the overall production time is long, and thus productivity is low. Further, because a press-forming tool is repeatedly subjected to large force, the lifespan thereof is short, and maintenance thereof is costly and time-consuming. There is also a problem of having to frequently replace the bulky and heavy processing tool.

### SUMMARY

An aspect of the present disclosure is directed to a motor for an electric vehicle, more particularly, to solving a problem with the related art that a hairpin, which is manufactured in a predetermined three-dimensional shape by processing a material coil, has large variation in shape.

Another aspect of the present disclosure is directed to solving a problem with the related art that a bent portion of a material coil easily cracks or an insulating film is easily damaged.

Still another aspect of the present disclosure is directed to solving a problem with the related art that the replacement cycle of a processing tool for processing a material coil is short and replacement of the processing tool is costly and time-consuming.

The aspects of the present disclosure are not limited to those mentioned above, and other aspects or objects not mentioned herein will be clearly understood by those skilled in the art from the following description.

A hairpin forming apparatus according to an embodiment of the present disclosure is an apparatus for forming a hairpin for a motor, and includes: a stopper configured to sense contact of a leading end of a material coil fed in one direction and to align the leading end of the material coil at a predetermined position; a cutter comprising a cutting blade positioned a predetermined distance from the stopper, the cutter being configured to cut the material coil aligned by the stopper to a predetermined length; a coil holder provided between the stopper and the cutter, the coil holder being configured to allow the material coil to be placed thereon; and a press module configured to press and bend the material coil placed on the coil holder.

According to another aspect, a hairpin forming apparatus is a processing apparatus for manufacturing a hairpin by processing a linear material coil, and includes a stopper, a cutter, a coil holder, and a press module. The stopper senses contact of a leading end of the material coil fed in one direction and aligns the leading end of the material coil at a predetermined position. The cutter includes a cutting blade spaced a predetermined distance from the stopper, and cuts the material coil aligned by the stopper to a predetermined length. The coil holder is provided between the stopper and the cutter, and the material coil is placed on the coil holder. The press module presses and bends the material coil placed on the coil holder. The press module includes a die block fixed to a front surface of the coil holder, the die block having a die processing surface formed on a portion of an outer surface thereof, a main press configured to press the material coil toward the die block to form a pin head and pin shoulders, and a side press configured to press both sides of the material coil located at positions deviating from the die block and the main press from above to below to form a pair of pin arms.

In the hairpin forming apparatus according to the embodiment of the present disclosure, the main press includes a main lifting unit configured to ascend and descend along with rotation of a drive cam shaft, an upper press body coupled to a lower end of the main lifting unit so as to ascend and descend vertically above the die block, and a center press body provided between the die block and the upper press body, the center press body being configured to press the material coil forward toward the upper press body to form the pin head.

Alternatively, in the hairpin forming apparatus according to the embodiment of the present disclosure, the upper press body includes a base block including a rear surface formed to be flat, a base processing surface formed on a front surface thereof such that a height and a forward-backward thickness of the base processing surface gradually decrease from a center thereof to both sides thereof, and first and second coupling portions provided above the base processing surface, a shoulder block coupled to the second coupling portion, the shoulder block including a front surface protruding farther forward than the base processing surface and an upper end formed horizontally, the shoulder block being formed such that a vertical length thereof gradually increases downward from a center thereof to both sides thereof, and an upper coupling knob coupled to the first coupling portion so as to be in contact with an upper surface of the shoulder block, the upper coupling knob including an upper end portion coupled to the main lifting unit.

In the hairpin forming apparatus according to the embodiment of the present disclosure, the upper press body and the center press body of the main press may be separable from each other.

Alternatively, in the hairpin forming apparatus according to the embodiment of the present disclosure, the base block and the shoulder block of the upper press body may be separately replaceable.

In the hairpin forming apparatus according to the embodiment of the present disclosure, the center press body may include a center processing surface formed in a shape corresponding to the base processing surface while facing the base processing surface and a center coupling knob extending in a direction opposite the center processing surface through the coil holder and a mounting frame.

Alternatively, in the hairpin forming apparatus according to the embodiment of the present disclosure, the center processing surface of the center press body may move forward and backward toward the base processing surface through the mounting frame and the coil holder.

A vehicle may include the motor having the hairpin formed by the apparatus.

An electric vehicle may include the motor having the hairpin formed by the apparatus.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a view for explaining a hairpin of a motor;

FIG. 2 is a perspective view for explaining a material coil wound on a winding bobbin;

FIG. 3 is a flowchart for explaining a process of manufacturing a hairpin of a motor;

FIG. 4 is a hairpin manufacturing process diagram schematically showing the entire process of manufacturing a hairpin of a motor;

FIG. 5 is a front view schematically showing an apparatus for forming a hairpin according to an embodiment of the present disclosure;

FIG. 6 is an exploded perspective view showing an upper press body in the apparatus for forming a hairpin according to the embodiment of the present disclosure;

FIG. 7 is a perspective view showing the upper press body in the apparatus for forming a hairpin according to the embodiment of the present disclosure;

FIG. 8 is a longitudinal-sectional view for explaining a press module in the apparatus for forming a hairpin according to the embodiment of the present disclosure; and

FIGS. 9 and 10 are views showing a process in which a linear material coil is processed in a shape of a hairpin by the apparatus for forming a hairpin according to the embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings.

In the following description of the embodiments disclosed in the present specification, a detailed description of known functions and configurations incorporated herein will be omitted when the same may make the subject matter of the embodiments disclosed in the present specification rather unclear.

In addition, the accompanying drawings are provided only for a better understanding of the embodiments disclosed in the present specification and are not intended to limit the technical ideas disclosed in the present specification.

It will be understood that when a component is referred to as being “connected to” or “coupled to” another component, it may be directly connected to or coupled to the other component, or intervening components may be present.

The first direction X, the second direction Y, and the third direction Z described herein refer to respective dimensions and directions of a three-dimensional coordinate system for describing a three-dimensional shape. Thus, the first direction X, the second direction Y, and the third direction Z may be indicated by arrows intersecting each other perpendicularly in space.

The present disclosure relates to an apparatus 68 for forming a hairpin 10.

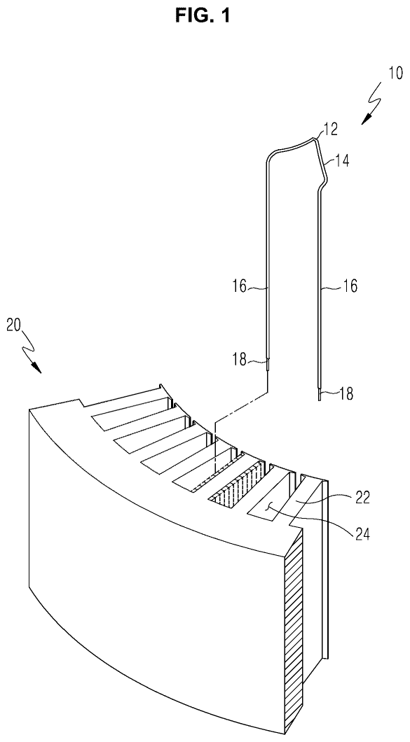

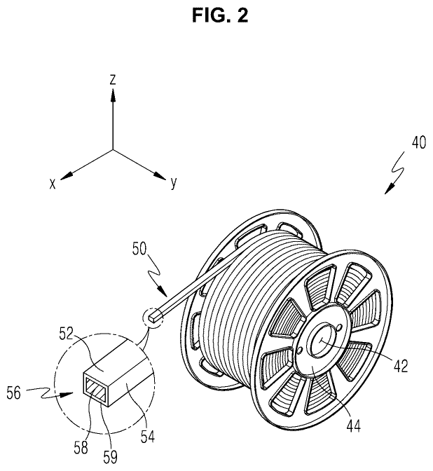

FIG. 1 is a view for explaining a hairpin of a motor, and FIG. 2 is a perspective view for explaining a material coil wound on a winding bobbin.

Referring to FIGS. 1 and 2, an electric motor includes a stator 20 and a rotor.

The stator 20 corresponds to a fixed part of the motor, and a material coil 50 is wound on a stator core 22 in a predetermined direction.

As shown in the drawings, the material coil 50 may be processed in the shape of a hairpin 10, and may be coupled to the stator core 22. The stator core 22 may be provided in plural, and the plurality of stator cores 22 may be disposed at regular intervals. Each of stator slots 24 is formed between adjacent ones of the stator cores 22.

The material coil 50 may be cut to a predetermined length (feed pitch), and the cut material coil may be transformed into a hairpin 10. The hairpin 10 may be mounted in each of the stator slots 24.

When current is applied to the hairpins 10 densely coupled to the stator 20, a magnetic field is formed around the stator 20. Then, the rotor rotates relative to the stator 20 under the influence of the magnetic field formed around the stator 20.

The apparatus 68 for forming the hairpin 10 according to the embodiment of the present disclosure may be utilized in a process of manufacturing the hairpin 10.

The hairpin 10 is manufactured by processing the material coil 50 cut to a predetermined length (hereinafter referred to as a “feed pitch”). Alternatively, in some embodiments of the present disclosure, a bending, stripping, or notching process may be performed in advance on some portions of the material coil 50, and the process of cutting the material coil 50 in units of feed pitch may be performed after the processing and stripping processes.

The material coil 50 is a linear conductive wire having a rectangular cross-section.

In detail, the material coil 50 includes a conductive core 58 made of a conductive material and an insulating film 59 coated on the surface of the conductive core 58. The conductive core 58 may be a linear copper member having a rectangular cross-section, and the insulating film 59 may be an insulative material, such as enamel, coated on the surface of the conductive core 58 to a predetermined thickness.

The hairpin 10 is manufactured by cutting the linear material coil 50 to a predetermined length, and a pair of conductive terminals 18 is formed at respective ends of the hairpin 10. The pair of conductive terminals 18 is formed at respective ends of the hairpin 10 so as to have a predetermined length.

The conductive terminals 18 correspond to portions of the material coil 50 from which the insulating film 59 is removed. The conductive terminals 18 may serve as terminals for electrical connection.

The hairpin 10 may be divided into a pin head 12, pin shoulders 14, pin arms 16, and the aforementioned conductive terminals 18.

The pin head 12 is located at the center of the hairpin 10. The pin head 12 corresponds to a vertex portion bent at a predetermined angle.

The pin head 12 is a point at which the pair of pin shoulders 14 meets each other. The pair of pin shoulders 14 is linear portions extending bilaterally from the pin head 12.

Based on the state in which the sharp bent portion of the pin head 12 is directed upward as shown in FIG. 1, the pair of pin shoulders 14 may correspond to two sides of a virtual triangle that form a contained angle therebetween, with the vertex of the angle being the pin head 12, in the plan view and the front view.

The pin arms 16 extend downward from the ends of the respective pin shoulders 14. The pin arms 16 form linear portions extending straight in an upward-downward direction, and the conductive terminals 18 are provided at the lower ends of the respective pin arms 16. Further, the two pin arms 16 may be disposed parallel to each other.

The material coil 50 used for manufacture of the hairpin 10 is a linear member having a rectangular cross-section, and is usually stored and transported in the state of being wound on a winding bobbin 40.

The winding bobbin 40 may include a bobbin core 44 having a cylindrical shape, shielding plates mounted on respective ends of the bobbin core 44, and a center hole 42 as a through-hole formed through the center of the bobbin core 44 in the longitudinal direction of the bobbin core 44.

The material coil 50 having a rectangular cross-section includes a long side portion 52 having a relatively long length and a short side portion 54 having a relatively short length.

The pair of pin shoulders 14 is portions extending straight bilaterally from the pin head 12, and the pair of pin arms 16 is linear portions bent and extending downward from the ends of the respective pin shoulders 14.

The material coil 50 cut in units of feed pitch has the pair of conductive terminals 18 formed at respective ends thereof. A linear wire portion interconnecting the pair of conductive terminals 18 undergoes a bending process so as to have a predetermined three-dimensional shape, and thus is transformed into one hairpin 10 composed of the pin head 12, the pin shoulders 14, and the pin arms 16.

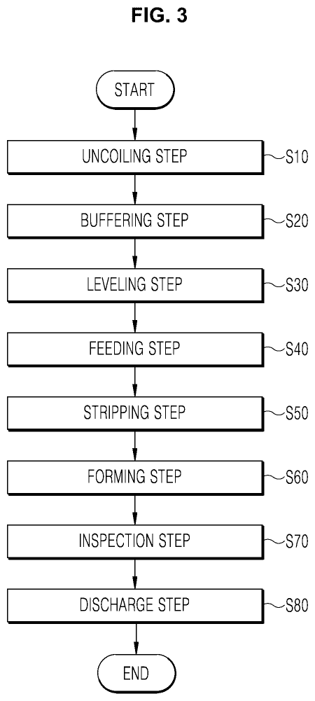

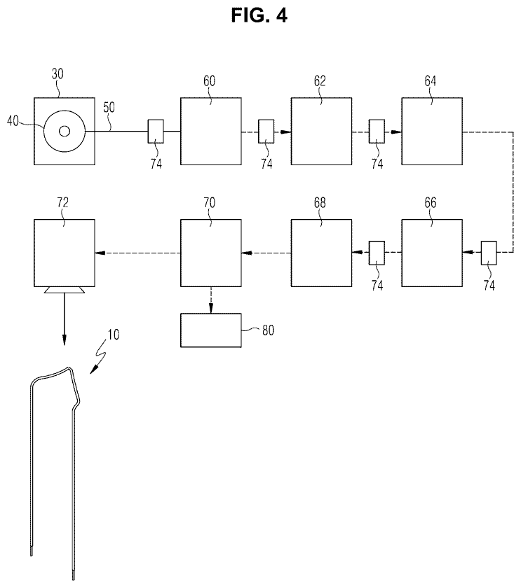

FIG. 3 is a flowchart for explaining a process of manufacturing a hairpin of a motor, and FIG. 4 is a hairpin manufacturing process diagram schematically showing the entire process of manufacturing a hairpin of a motor.

As shown in FIGS. 3 and 4, the process of manufacturing the hairpin 10 may include an uncoiling step S10, a buffering step S20, a leveling step S30, a feeding step S40, a stripping step S50, a forming step S60, an inspection step S70, and a discharge step S80.

The uncoiling step S10 is a step of unwinding the material coil 50 having a rectangular cross-section from the winding bobbin 40 using an uncoiling apparatus 30 and feeding the unwound material coil 50 straight from one end of the winding bobbin 40.

The buffering step S20 is a step of storing the material coil 50 unwound from the winding bobbin 40 and fed straight so that the material coil 50 is fed without delay by unit length for manufacture of the hairpin 10. That is, the buffering step S20 is a step of sufficiently securing the length of the unwound material coil 50, which is capable of being fed, to a predetermined length or longer using a buffering apparatus 60.

The leveling step S30 is a step of straightening the material coil 50 unwound from the winding bobbin 40 using a leveling apparatus 62.

The feeding step S40 may be performed through a feeding apparatus 64. The feeding apparatus 64 holds the material coil 50 and feeds the material coil 50 in a predetermined direction by a predetermined unit length.

The stripping step S50 is a step of removing the insulating film 59, such as enamel, coated on the surface of the material coil 50. The stripping step S50 may be performed through a stripping apparatus 66, and may further include a notching process for the conductive terminals 18 that are formed through removal of the insulating film 59.

The forming step S60 is a step of cutting the material coil 50 to the length for manufacture of each hairpin 10, i.e., the feed pitch, and bending the material coil 50 cut to the feed pitch using the forming apparatus 68, thereby forming the pin head 12, the pin shoulders 14, and the pin arms 16.

The inspection step S70 is a step of inspecting the hairpin 10 having undergone the forming step S60 using an inspection apparatus 70 to determine whether the hairpin 10 is a non-defective product or a defective product.

The discharge step S80 is a step of feeding the hairpin 10 determined to be a non-defective product in the inspection step S70 to a discharge apparatus 72. The hairpin 10 determined to be a non-defective product may be moved along the discharge apparatus 72 and may be loaded at a predetermined position.

Feeding guides 74 may be provided between the apparatuses for performing the above-described respective processes in order to correct the direction and position of the material coil 50 that is fed between the apparatuses.

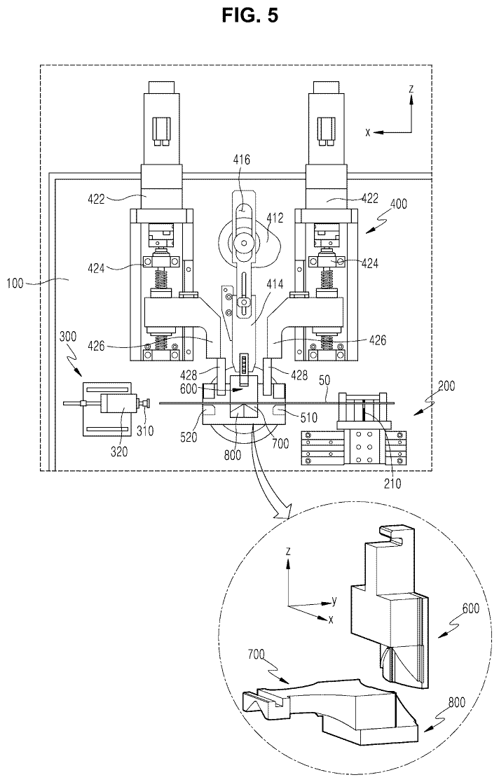

FIG. 5 is a front view schematically showing an apparatus for forming the hairpin 10 according to an embodiment of the present disclosure.

As shown in FIG. 5, in the embodiment of the present disclosure, the apparatus for forming the hairpin 10 includes a mounting frame 100, a stopper 300, a cutter 200, a coil holder 500, and a press module 400.

The stopper 300 senses whether the leading end of the material coil 50 fed in one direction comes into contact therewith. Upon sensing contact of the leading end of the material coil 50, the stopper 300 places the leading end of the material coil 50 at a predetermined point on the coil holder 500.

The material coil 50 is fed horizontally in the X-axis longitudinal direction. Based on FIG. 5, the leading end of the material coil 50 is fed from left to right parallel to the X-axis.

The stopper 300 is provided at the front of the path along which the material coil 50 is fed, and senses whether the leading end of the material coil 50 comes into contact with an alignment end 310. The stopper 300 may further include an alignment drive unit 320 to move the alignment end 310 to a predetermined position. The alignment drive unit 320 moves and aligns the material coil 50, the leading end of which is in contact with the alignment end 310, in the X-axis longitudinal direction so that the material coil 50 is placed at a predetermined position.

The cutter 200 is provided at a position spaced a predetermined distance from the stopper 300. The cutter 200 includes a cutting blade 210 to cut the material coil 50, the leading end of which is aligned in position by the stopper 300, to a predetermined length. The cutting blade 210 is provided on the feeding path of the material coil 50, and is spaced a predetermined distance from the stopper 300.

The coil holder 500 is located between the stopper 300 and the cutter 200 on the feeding path of the material coil 50 fed parallel to the X-axis.

The coil holder 500 supports the material coil 50 that is laid lengthwise in a horizontal direction to prevent bending or sagging of the material coil 50, and allows the material coil 50 to be fed straight along the straight feeding path.

The coil holder 500 may include a first support member 510 and a second support member 520. The coil holder 500 may include a plate-shaped member mounted on the front surface of the mounting frame 100, and the first support member 510 and the second support member 520 may be provided so as to protrude forward. The first support member 510 and the second support member 520 are located on both sides of the press module 400, and stably fix both sides of processed portion of the material coil 50 during processing of the material coil 50.

The press module 400 may be a processing frame configured to press and bend the material coil 50 laid lengthwise between the stopper 300 and the cutter 200 to a predetermined shape.

The leading end of the material coil 50 is aligned in contact with the alignment end 310 of the stopper 300. In this aligned state, the material coil 50 is cut to a predetermined length (feed pitch) by the cutter 200, and the cut material coil 50 is placed on the coil holder 500.

The first support member 510 and the second support member 520 of the coil holder 500 are disposed on both sides of the press module 400 so as to be adjacent thereto, and the press module 400 is provided between the first support member 510 and the second support member 520.

The press module 400 includes a die block 800, a main press 410, and a side press 420. The die block 800 is fixed to the front surface of the coil holder 500 and is mounted between the first support member 510 and the second support member 520. At least a portion of the outer surface of the die block 800 that is exposed toward the front surface of the coil holder 500 may be formed as a die processing surface 820.

The main press 410 presses the material coil 50 placed on the coil holder 500 in the −Z-axis direction and the +Y-axis direction toward the fixed die block 800, thereby transforming the material coil 50 into the hairpin 10 having the pin head 12 and the pin shoulders 14.

The main press 410 includes a main lifting unit 414, an upper press body 600, and a center press body 700.

The main lifting unit 414 ascends and descends in an upward-downward direction on the front surface of the mounting frame 100. In the embodiment of the present disclosure, the main lifting unit 414 may ascend and descend due to conversion of the rotational motion of a drive cam shaft 412 into upward-downward linear reciprocating motion. The main lifting unit 414 may have a cam coupling hole 416 formed therein, and the drive cam shaft 412 may be coupled in the cam coupling hole 416 in the main lifting unit 414. The rotational motion of the drive cam shaft 412 is converted into the lifting motion of the main lifting unit 414. The upper press body 600 is coupled to the main lifting unit 414 to ascend and descend in the ±Z-axis directions together with the main lifting unit 414, thereby pressing the material coil 50 in the −Z-axis direction toward the die block 800.

The center press body 700 presses the material coil 50 in the +Y-axis direction toward the die block 800.

In addition, the side press 420 presses both sides of the material coil 50 that are located at positions deviating from the die block 800 and the main press 410 from above to below, thereby forming the pair of pin arms 16.

The side press 420 includes a pair of side motors 422, a pair of side lifting units 424, a pair of side press blocks 426, and a pair of side lifting blocks 428, which are disposed on both sides of the main press 410.

The side lifting units 424 ascend and descend in the upward-downward direction along with operation of the side motors 422. The side press blocks 426 are coupled to the side lifting units 424 to ascend and descend along with ascent and descent of the side lifting units 424.

The pair of side press blocks 426 mounted on both sides of the main press 410 moves the side lifting blocks 428 located on both sides of the main press 410 so as to be adjacent thereto in the upward-downward direction.

One of the pair of side lifting blocks 428 is located in a space between the main press 410 and the first support member 510 so as to be ascendable and descendable in the upward-downward direction, and the other of the pair of side lifting blocks 428 is located in a space between the main press 410 and the second support member 520 so as to be ascendable and descendable in the upward-downward direction.

The middle portion of the material coil 50 is pressed in the ±X-axis directions and the ±Z-axis directions between the main press 410 and the die block 800, and thus is transformed into the pin head 12 and the pin shoulders 14. In addition, both side portions of the material coil 50, peripheral to the pin head 12 and the pin shoulders 14, are pressed from above to below by the side lifting blocks 428 of the side press 420, and thus are transformed into the pin arms 16.

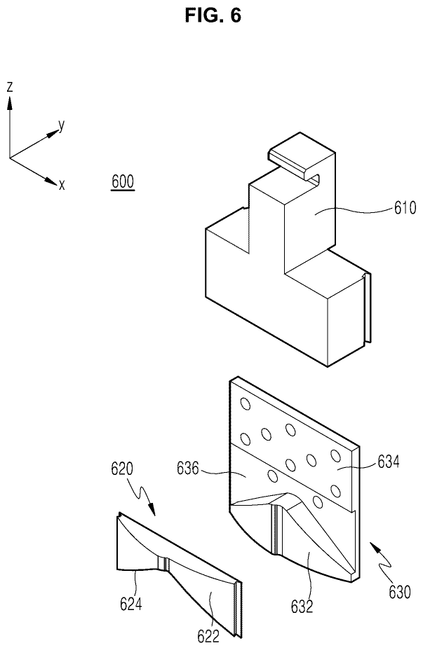

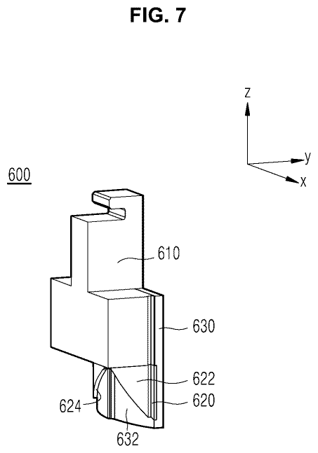

FIG. 6 is an exploded perspective view showing the upper press body 600 in the apparatus for forming the hairpin 10 according to the embodiment of the present disclosure, and FIG. 7 is a perspective view showing the upper press body 600 in the apparatus for forming the hairpin 10 according to the embodiment of the present disclosure.

As shown in FIGS. 6 and 7, the upper press body 600 may be separated into an upper coupling knob 610, a shoulder block 620, and a base block 630. That is, the upper coupling knob 610, the shoulder block 620, and the base block 630 are combined to form the upper press body 600.

The base block 630 includes a base processing surface 632, a first coupling portion 634, and a second coupling portion 636.

The rear surface (+Y-axis direction) of the base block 630 may be formed as a flat surface, and the base processing surface 632 may be a three-dimensional surface protruding forward (−Y-axis direction), i.e., in a direction opposite the rear surface formed to be flat.

The base processing surface 632 is formed such that the height of a protruding portion thereof and the thickness of the protruding portion from the rear surface gradually decrease from the center portion thereof to both sides thereof. That is, as shown in the drawings, the base processing surface 632 is a three-dimensional surface oriented in the −Y-axis direction, and has a predetermined curved surface that gradually decreases in height and thickness from the center thereof to both sides thereof.

The first coupling portion 634 and the second coupling portion 636 are provided above the base processing surface 632.

The first coupling portion 634 may be formed as a flat surface facing forward (−Y-axis direction), and may have formed therein a plurality of fastening holes through which fastening members such as bolts are fastened in order to be coupled to the upper coupling knob 610 contacting the front surface thereof.

The second coupling portion 636 may be located under the first coupling portion 634 and on the base processing surface 632, and may be provided in the form of a type of recess between the first coupling portion 634 and the base processing surface 632.

The shoulder block 620 is coupled to the front surface of the second coupling portion 636.

The shoulder block 620 is coupled to the second coupling portion 636. The front surface of the shoulder block 620 is a shoulder processing surface 622, which is formed as a three-dimensional surface protruding farther forward than the base processing surface 632. The upper end of the shoulder block 620 is formed as a horizontal surface. The vertical length of the shoulder block 620 gradually increases downward from the center thereof to both sides thereof.

The upper coupling knob 610 is coupled to the first coupling portion 634 in the state in which at least a portion of the upper coupling knob 610 is in contact with the upper surface of the shoulder block 620 that is formed to be flat. In addition, the upper end portion of the upper coupling knob 610 may be coupled to the main lifting unit 414.

The upper coupling knob 610, the shoulder block 620, and the base block 630 may be coupled to each other to form the upper press body 600, and may be separated from each other to be replaced independently.

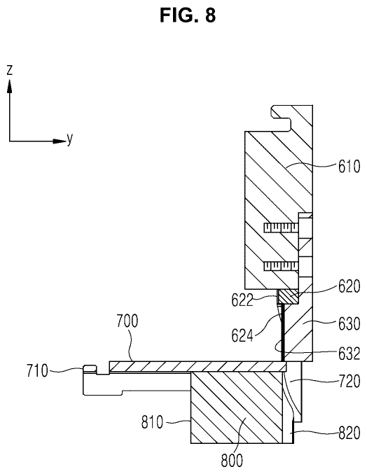

FIG. 8 is a longitudinal-sectional view for explaining the press module 400 in the apparatus for forming the hairpin 10 according to the embodiment of the present disclosure.

As shown in FIG. 8, the center press body 700 includes a center processing surface 720 and a center coupling knob 710.

The center processing surface 720 is a three-dimensional surface that faces the above-described base processing surface 632 and is oriented in the +Y-axis direction.

The center processing surface 720 is a surface having a shape corresponding to the base processing surface 632, and the center processing surface 720 and the base processing surface 632 are formed to be in contact with each other without a gap while facing each other.

The center press body 700 may linearly reciprocate in the ±Y-axis direction while passing through the mounting frame 100 and the coil holder 500 in the ±Y-axis direction.

The center coupling knob 710 is provided opposite the center processing surface 720. The center coupling knob 710 extends in the −Y-axis direction through the mounting frame 100 and the coil holder 500.

The center coupling knob 710 may be connected to a drive unit. The center processing surface 720 is provided to linearly reciprocate forward and backward in the ±Y-axis directions.

The die block 800 includes a die processing surface 820, which is a three-dimensional surface oriented in the same direction as the center processing surface 720, and a die fixing surface 810, which is formed to be flat at a position opposite the die processing surface 820.

The die fixing surface 810 may be in contact with and coupled to the front surface of the mounting frame 100 or the front surface of the coil holder 500.

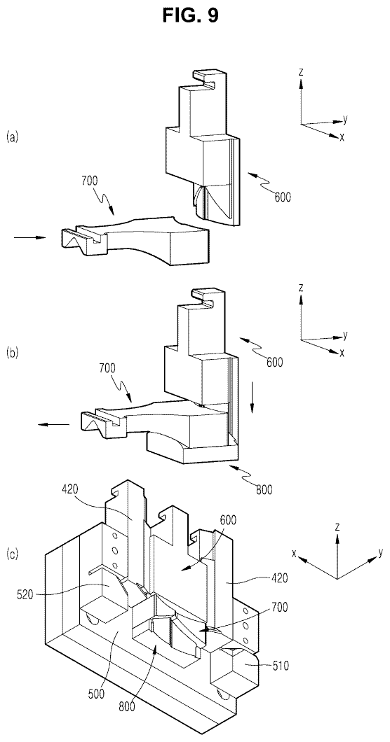

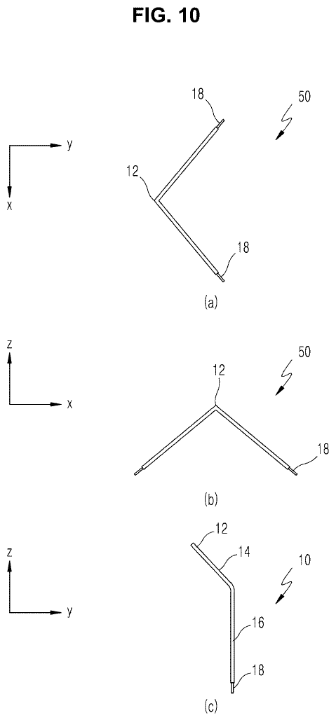

FIGS. 9 and 10 are views showing a process in which the linear material coil 50 is processed in the shape of the hairpin 10 by the apparatus for forming the hairpin 10 according to the embodiment of the present disclosure.

As shown in FIGS. 9 and 10, the leading end of the material coil 50 fed in the +X-axis direction is aligned in position by the stopper 300, and then the material coil 50 is cut to a predetermined length, i.e., the feed pitch, by the cutter 200. The cut material coil 50 is placed on the front surface of the coil holder 500 in the X-axis longitudinal direction.

The upper press body 600 is primarily lowered toward the die block 800, so the material coil 50 is located at the front of the base processing surface 632 of the upper press body 600.

The center press body 700 presses the middle portion of the material coil 50 in the +Y-axis direction to process the material coil 50 between the base processing surface 632 and the center processing surface 720. In the embodiment of the present disclosure, the pin head 12 of the hairpin 10 may be formed through this process.

The center press body 700 moves backward to form a step with the die block 800. The length of the step formed between the center press body 700 moving backward and the die block 800 may correspond to the thickness of the material coil 50.

The die block 800 forms a lower processing frame, and the center processing surface 720 of the center press body 700 forms a processing frame on the X-Z plane. In this state, the upper press body 600 is secondarily lowered to bend both sides of the pin head 12 of the material coil 50 downward, thereby forming the pin shoulders 14.

In this way, the pin head 12 and the pin shoulders 14 are formed by the main press 410 and the die block 800. The side press 420 is lowered to press both sides of the material coil 50 that are located at positions deviating from the main press 410 and the die block 800, thereby forming the pair of pin arms 16 extending downward parallel to each other.

After the material coil 50 is completely processed in the shape of the hairpin 10, the side press 420 and the upper press body 600 are raised, and the center press body 700 is moved in the +Y-axis direction, thereby allowing the hairpin 10 placed on the die block 800 to be separated and fall freely from the hairpin forming apparatus according to the embodiment of the present disclosure.

As is apparent from the above description, according to the present disclosure, a cutter for cutting a linear material coil has a small volume and a simple structure, thereby more rapidly and accurately cutting the material coil.

According to the present disclosure, each of a press and a die for processing a material coil is constituted by a plurality of parts separably coupled to each other. Thus, only a worn processing surface or a part that needs replacement is selectively replaced, leading to reduction in time and cost required for maintenance of the press and the die.

According to the present disclosure, a linear material coil is processed in the forward-backward direction and the upward-downward direction so that individual portions constituting a hairpin are formed sequentially, whereby variation in the shape of the manufactured hairpin may be reduced, and damage to bent portions of the hairpin may be prevented.

The effects achievable through the disclosure are not limited to the above-mentioned effects, and other effects not mentioned herein will be clearly understood by those skilled in the art from the above description.

The embodiments of the present disclosure have been described above with reference to the accompanying drawings. However, the embodiments are only proposed for illustrative purposes, and the present disclosure is not limited to the above-described embodiments and the accompanying drawings.

It will be apparent to those skilled in the art that various changes in form and details may be made without departing from the scope and spirit of the disclosure. It is to be understood that the embodiments described herein are part of the present disclosure.

The embodiments described herein should not be construed as limiting the scope of the present disclosure. The scope of the present disclosure should be defined by the technical spirit set forth in the appended claims.

In addition, although not all actions or effects according to the configuration of the embodiments have been explicitly described, it is apparent that actions or effects predictable from the configuration should also be recognized as falling within the spirit and scope of the present disclosure.

What is claimed is:

1. An apparatus for forming a hairpin for a motor, the apparatus comprising:
a stopper configured to sense contact of a leading end of a material coil fed in one direction and to align the leading end of the material coil at a predetermined position;
a cutter comprising a cutting blade positioned a predetermined distance from the stopper, the cutter being configured to cut the material coil aligned by the stopper to a predetermined length;
a coil holder provided between the stopper and the cutter, the coil holder being configured to allow the material coil to be placed thereon; and
a press module configured to press and bend the material coil placed on the coil holder.

2. The apparatus according to claim 1, wherein the press module comprises:
a die block fixed to a front surface of the coil holder, the die block having a die processing surface formed on a portion of an outer surface thereof;
a main press configured to press the material coil toward the die block to form a pin head and pin shoulders; and
a side press configured to press both sides of the material coil extending beyond the die block and the main press, pressing from above to below to form a pair of pin arms.

3. The apparatus according to claim 2, wherein the main press comprises:
a main lifting unit configured to ascend and descend along with rotation of a drive cam shaft;
an upper press body coupled to a lower end of the main lifting unit so as to ascend and descend vertically above the die block; and
a center press body provided between the die block and the upper press body, the center press body being configured to press the material coil forward toward the upper press body to form the pin head.

4. The apparatus according to claim 3, wherein the upper press body comprises:
a base block comprising a rear surface formed to be flat, a base processing surface formed on a front surface thereof such that a height and a forward-backward thickness of the base processing surface gradually decrease from a center thereof to both sides thereof, and first and second coupling portions provided above the base processing surface;
a shoulder block coupled to the second coupling portion, the shoulder block comprising a front surface protruding farther forward than the base processing surface and an upper end formed horizontally, the shoulder block being formed such that a vertical length thereof gradually increases downward from a center thereof to both sides thereof; and
an upper coupling knob coupled to the first coupling portion so as to be in contact with an upper surface of the shoulder block, the upper coupling knob comprising an upper end portion coupled to the main lifting unit.

5. The apparatus according to claim 4, wherein the upper press body and the center press body of the main press are detachably connected.

6. The apparatus according to claim 4, wherein the base block and the shoulder block of the upper press body are separately replaceable.

7. The apparatus according to claim 4, wherein the center press body comprises:
a center processing surface formed as a three-dimensional surface corresponding to the base processing surface while facing the base processing surface; and
a center coupling knob extending in a direction opposite the center processing surface through the coil holder and a mounting frame.

8. The apparatus according to claim 7, wherein the center processing surface of the center press body moves forward and backward toward the base processing surface through the mounting frame and the coil holder.

9. The apparatus according to claim 1, wherein the hairpin if formed by processing a linear material coil.

10. A vehicle comprising the motor having the hairpin formed by the apparatus of claim 1.

11. An electric vehicle comprising the motor having the hairpin formed by the apparatus of claim 1.
